(19) United States
(12) Patent Application Publication
(10) Pub. No.: US 2014/0174897 A1
(43) Pub. Date: Jun. 26, 2014

(54) ELECTRONIC DEVICE WITH BUTTON ASSEMBLY

(71) Applicants: HON HAI PRECISION INDUSTRY CO., LTD., New Taipei (TW); Fu Tai Hua Industry (Shenzhen) Co., Ltd., Shenzhen (CN)

(72) Inventor: Yan-Bang CAO, Shenzhen (CN)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 13/973,976

(22) Filed: Aug. 22, 2013

(30) Foreign Application Priority Data
Dec. 26, 2012 (CN) 2012105709227

(51) Int. Cl. H01H 13/52

(52) U.S. Cl. CPC H01H 13/52
USPC 200/290

(57) ABSTRACT

An electronic device includes a button and a front panel having a button receiving hole to partly receive the button. A frame is secured to an inner side of the front panel, and includes a support portion spaced apart from the inner side of the front panel. A circuit board is secured to the support portion, and includes a switch under the button. An elastic member is located between the button and the support portion of the frame, and is used to apply a pushing force to the button.

### BACKGROUND

1. Technical Field

The present disclosure relates to an electronic device with a button assembly.

2. Description of Related Art

Many electronic devices such as tablet computers include a physical button. Many button assemblies of different structures have been proposed. However, an electronic device including a new button assembly is still needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric, partial view of an electronic device according to one embodiment, showing the inner side of a front panel.

FIG. 2 is an isometric, exploded view of the assembly of FIG. 1.

FIG. 3 is a cross-sectional view of the assembly of FIG. 1, taken along line III-III of FIG. 1.

FIG. 4 is an isomeric, exploded view of an electronic device similar to the electronic device of FIG. 1.

FIG. 5 is cross-sectional view of the electronic device of FIG. 4.

### DETAILED DESCRIPTION

Embodiments of the present disclosure will be described with reference to the accompanying drawings.

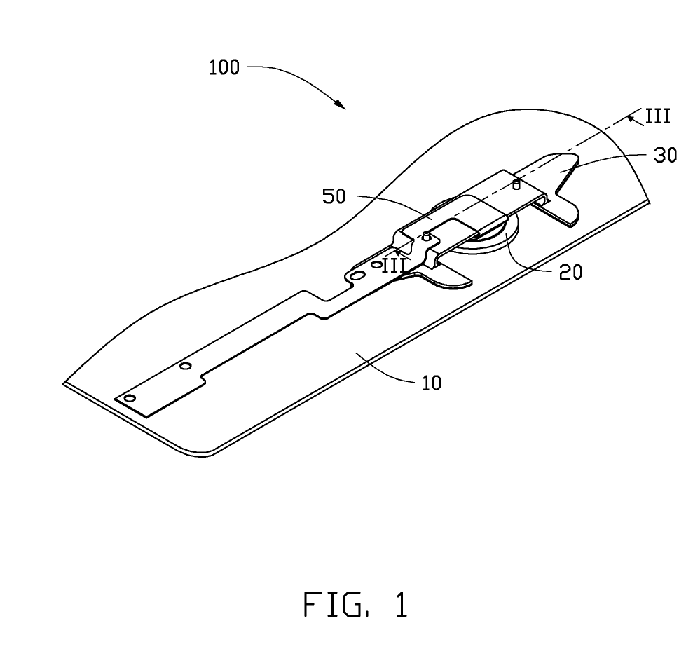

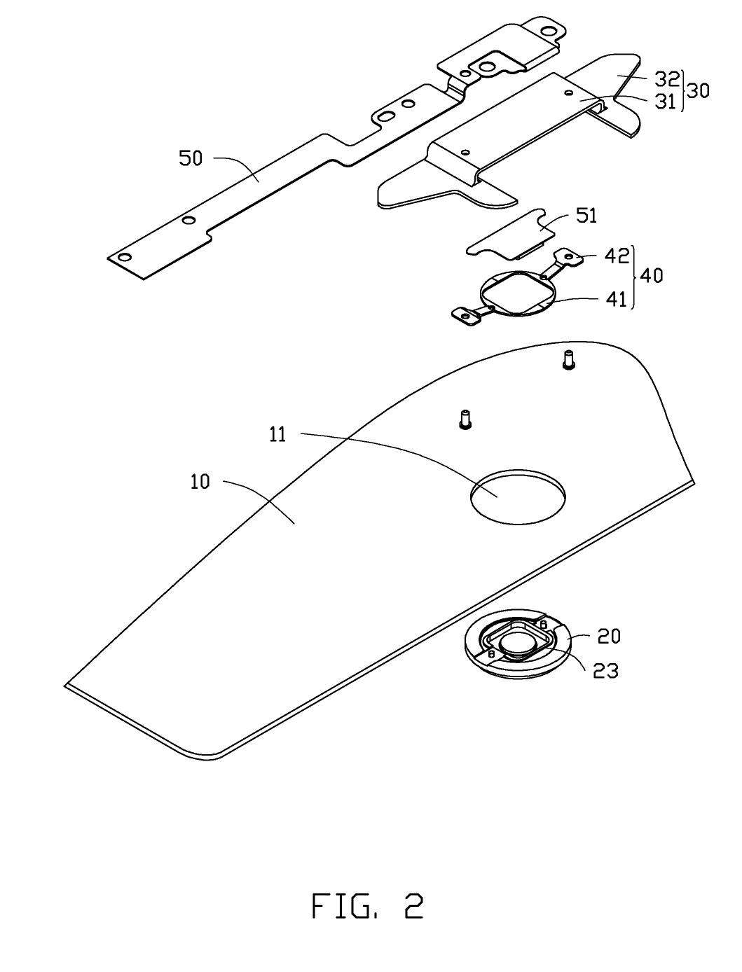

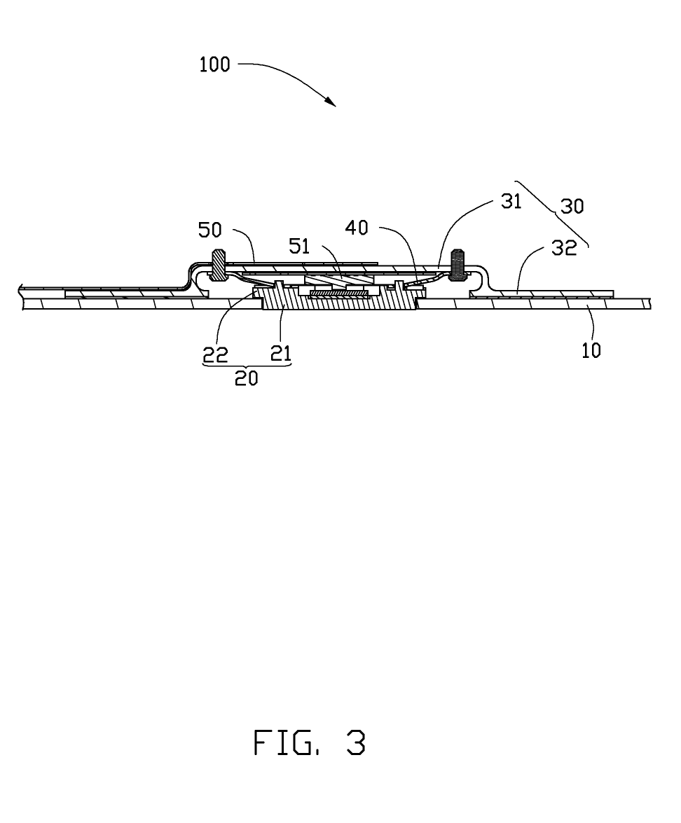

Referring to FIGS. 1-3, an electronic device 100 includes a front panel 10 and a button 20. The front panel 10 includes a touch panel and a protective glass plate covering the touch panel. The front panel 10 defines a button receiving hole 11 that partly receives the button 20. In the embodiment, the button 20 includes a body 21 and a flange 22 around the body 21. The body 21 is fit in the button receiving hole 11 and the flange 22 abuts against the inner side of the front panel 10.

The electronic device 100 further includes an internal frame 30, an elastic member 40, and a circuit board 50. The frame 30 includes a support portion 31 that is spaced apart from the inner side of the front panel 10, and two connecting portions 32 connected to opposite ends of the support portion 31. In the embodiment, the connecting portions 32 are secured to the inner side of the front panel 10 via adhesive tape. The support portion 31 and the front panel 10 cooperatively define a receiving space 33.

The elastic member 40 is received in the receiving space 33, and includes a main body 41 and two elastic arms 42 extending from main body 41. The main body 41 is received in a cavity 23 defined in the lower side of the button 20. In other embodiments, the cavity 23 may omitted, and the main body 41 may be directly secured to the lower side of the button 20. The ends of the elastic arms 42 are secured to the support portion 31 of the frame 30.

In the embodiment, the circuit board 50 is a flexible circuit board, and a portion of the circuit board 50 is secured to the support portion 31 and located in the receiving space 33. The circuit board 50 includes a switch 51 located in the receiving space 33 under the button 20.

When depressed, the button 20 moves down and actuates the switch 51. After the button 20 is released, the elastic member 40 rebounds and pushes the button 20 back to its original position.

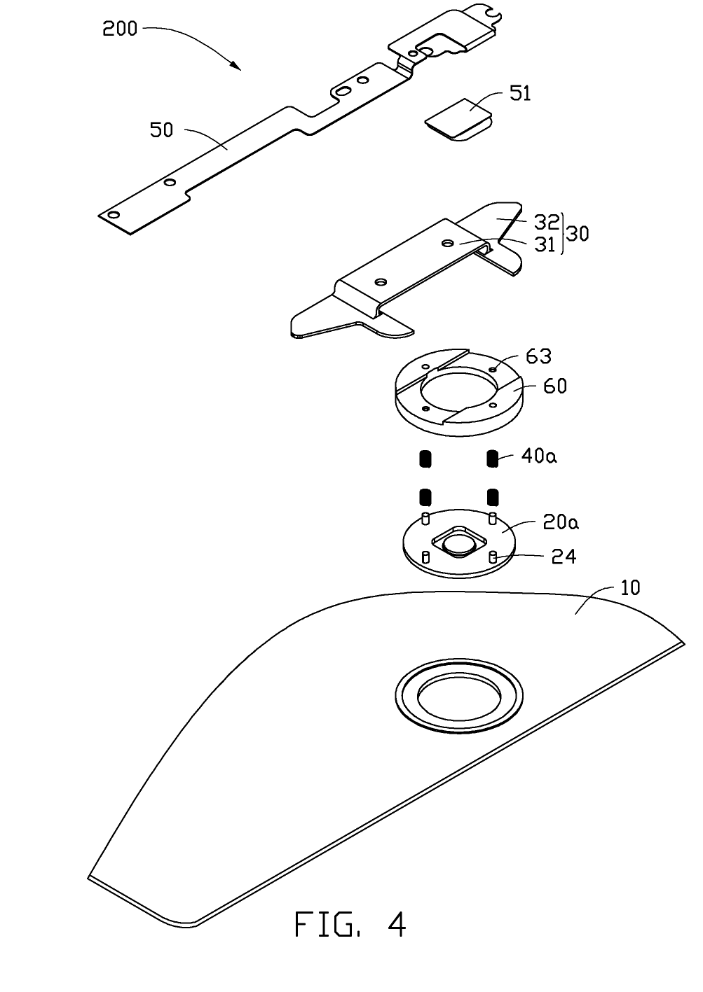

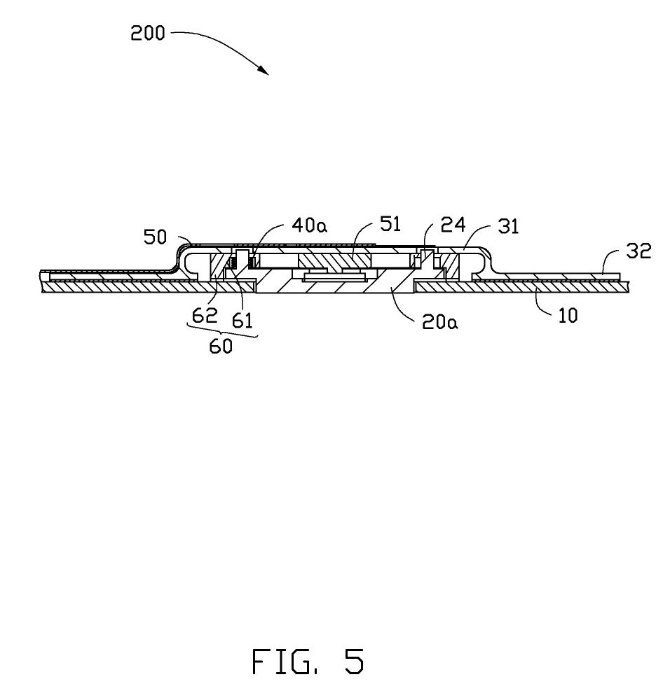

FIGS. 4-5 show an electronic device 200 similar to the electronic device 100. The electronic device 200 also includes a front panel, a circuit board, and a frame that are the same as those used in the electronic device 100. The electronic device 200 includes a button 20a that is similar to the button 20, but has a number of protrusions 24 protruding from its inner side. The electronic device 200 further includes a number of coil springs 40a, and a barrel 60. The barrel 60 includes a ring 61 and a sidewall 62 protruding from the edge of the ring 61. The end of the sidewall 62 is secured to the inner side of the front panel 10. Each of the coil springs 40a is coiled around one of the protrusions 24 of the button 20. The opposite ends of the coil spring 40a abut against the inner side of the front panel 10 and the inner side of the ring 61. The ring 61 defines a number of through holes 63, through which the protrusions 24 of the button 20 extend. When depressed, the button 20a moves down and actuates the switch 51. After the button 20 is released, the coil springs 40a rebound and push the button 20a back to its original position.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. An electronic device comprising:
a button;
a front panel defining a button receiving hole to partly receive the button;
a frame secured to an inner side of the front panel, the frame comprising a support portion spaced apart from the inner side of the front panel;
a circuit board secured to the support portion, the circuit board comprising a switch under the button; and
an elastic member arranged between the button and the support portion of the frame, the elastic member being configured to apply a pushing force to the button.

2. The electronic device according to claim 1, wherein the frame comprises two connection portions connected to opposite ends of the support portion, and the connection portions are secured to the inner side of the front panel via adhesive tapes.

3. The electronic device according to claim 1, wherein the elastic member includes a main body and two arms extending from the main body, ends of the two arms are secured to the support portion of the frame, and the main body contacts the button.

4. The electronic device according to claim 3, wherein the main body is secured to the button with adhesive tapes.

5. The electronic device according to claim 1, further comprising a barrel secured to the inner side of the front panel, wherein opposite ends of the elastic member abut against the button and the barrel.

6. The electronic device according to claim 5, wherein the elastic member is a coil spring.
